(19) United States
(12) Patent Application Publication
(10) Pub. No.: US 2024/0385937 A1
(43) Pub. Date: Nov. 21, 2024

(54) ACTIVE NODE SELECTION FOR HIGH AVAILABILITY CLUSTERS

(71) Applicant: TELEFONAKTIEBOLAGET LM ERICSSON (PUBL), Stockholm (SE)

(72) Inventors: Mattias Rönnblom, Vikingstad (SE); Thomas Walldeen, LINKÖPING (SE)

(21) Appl. No.: 18/690,109

(22) PCT Filed: Sep. 10, 2021
(86) PCT No.: PCT/IB2021/058231

§ 371 Date: Mar. 7, 2024

(51) Int. Cl. G06F 11/20; G06F 9/50; G06F 11/07

(52) U.S. Cl. CPC G06F 11/2028; G06F 9/5038; G06F 11/0766

(57) ABSTRACT

A method by a node in a cluster of nodes to support active node selection in the cluster. The method includes publishing, to a notice board, a record associated with the node that indicates a priority of the node and that indicates that the node is in a passive state, changing a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster, and modifying the record associated with the node on the notice board to indicate that the node is in the active state.

### TECHNICAL FIELD

Embodiments described herein relate to the field of distributed computing systems, and more specifically to selecting a node to serve as the active node in a cluster of nodes.

### BACKGROUND

Redundancy is one way to improve the availability of a computing system. The basic principle in a redundant computing system is that every element that is essential to the functioning and performance of the system is duplicated (there are multiple instances of the element). In the event that one instance fails, one or more other redundant instances stand ready to take over or may indeed already be active. As a result, there is no single point of failure.

A group of nodes that work together to perform some function may be referred to as a cluster. In a typical cluster, all nodes provide the same functionality (they are interchangeable). The nodes may be using the same software and/or hardware implementation or may be using different software and/or hardware implementations.

One common type of cluster is an “active-passive” cluster, which strives to keep exactly one node in the active state at any time while all other nodes remain in the passive state. Passive nodes, although they do not serve any requests, are still available in that they are healthy and ready to take over as the active node if necessary.

Passive nodes are sometimes referred to as being on “standby,” occasionally with the distinction between “cold” and “hot” standby. “Hot” standby implies that the passive node can be quickly activated, while “cold” standby implies that more time-consuming operations may be needed to activate the passive node.

For active-passive clusters to function properly there must be protocols and procedures in place to determine which node is initially active and when and to which node to fail over to in the event that the active node fails (e.g., because it is taken down for maintenance or for another reason). It is important that the mechanism for selecting the active node, and propagating any changes across the cluster is robust, otherwise the cluster will not be highly available.

### SUMMARY

A method by a node in a cluster of nodes to support active node selection in the cluster, wherein each node in the cluster is communicatively coupled to a notice board. The method includes publishing, to the notice board, a record associated with the node that indicates a priority of the node and that indicates that the node is in a passive state, changing a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster, and modifying the record associated with the node on the notice board to indicate that the node is in the active state. The method may further include changing the state of the node from the active state to the passive state in response to a determination, based on a record on the notice board, that another node in the cluster is in the active state and has a higher priority than the node and modifying the record associated with the node on the notice board to indicate that the node is in the passive state.

A non-transitory machine-readable storage medium that provides instructions that, if executed by one or more processors of a computing device implementing a node in a cluster of nodes, will cause said node to perform operations for supporting active node selection in the cluster, wherein each node in the cluster is communicatively coupled to a notice board. The operations include publishing, to the notice board, a record associated with the node that indicates a priority of the node and that indicates that the node is in a passive state, changing a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster, and modifying the record associated with the node on the notice board to indicate that the node is in the active state. The method further includes changing the state of the node from the active state to the passive state in response to a determination, based on a record on the notice board, that another node in the cluster is in the active state and has a higher priority than the node and modifying the record associated with the node on the notice board to indicate that the node is in the passive state. The operations may further include changing the state of the node from the active state to the passive state in response to a determination, based on a record on the notice board, that another node in the cluster is in the active state and has a higher priority than the node and modifying the record associated with the node on the notice board to indicate that the node is in the passive state.

A computing device to implement a node in a cluster of nodes. The computing device includes one or more processors and a non-transitory machine-readable medium having computer code stored therein, which when executed by the one or more processors, causes the node to: publish, to the notice board, a record associated with the node that indicates a priority of the node and that indicates that the node is in a passive state, change a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster, and modify the record associated with the node on the notice board to indicate that the node is in the active state. The computer code, when executed by the one or more processors, may further cause the node to change the state of the node from the active state to the passive state in response to a determination, based on a record on the notice board, that another node in the cluster is in the active state and has a higher priority than the node and modify the record associated with the node on the notice board to indicate that the node is in the passive state.

### BRIEF DESCRIPTION OF THE DRAWINGS

The invention may best be understood by referring to the following description and accompanying drawings that are used to illustrate embodiments of the invention. In the drawings:

FIG. 1 is a diagram of an environment in which an active node selection process may be performed, according to some embodiments.

FIG. 2 is a sequence diagram illustrating a node starting up and going active, according to some embodiments.

FIG. 3 is a sequence diagram illustrating two nodes starting up simultaneously (or almost simultaneously) and agreeing on which one should go active, according to some embodiments.

FIG. 4 is a sequence diagram illustrating a failover scenario, according to some embodiments.

FIG. 5 is a sequence diagram illustrating an operator-initiated switchback, according to some embodiments.

FIG. 6 is a sequence diagram illustrating a network outage induced inconsistency, according to some embodiments.

FIG. 7 is a flow diagram of a method for supporting active node selection in a cluster of nodes, according to some embodiments.

FIG. 8A illustrates connectivity between network devices (NDs) within an exemplary network, as well as three exemplary implementations of the NDs, according to some embodiments.

FIG. 8B illustrates an exemplary way to implement a special-purpose network device according to some embodiments.

### DETAILED DESCRIPTION

The following description describes methods and apparatus for providing active node selection in a cluster of nodes. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Selecting (or negotiating) the node to serve as the active node (also referred to as the “master” node) in a high-availability cluster of nodes often involves the use of complex, custom, and proprietary protocols. According to an existing approach, advisor locks (or the equivalent) of a relational database management system (RDBMS) are used to select the active node in a cluster. However, the strict atomicity-consistency-isolation-durability (ACID) semantics of RDBMS transactions makes scaling out and distribution (especially across high-latency links) with this approach difficult. According to another existing approach, file system-level locks are used to the same/similar effect but these might not be available or reliable in a distributed file system.

Embodiments are described herein that are able to provide active node selection in a cluster of nodes. Embodiments use a protocol that is less complicated compared to the ones used by existing approaches and that can leverage an already-existing and already-available data storage as a means for sharing information among the nodes in the cluster. The data storage may be used to implement a notice board. Each node in the cluster may publish a record to the notice board that indicates the node's priority (for active node selection) and the node's current state (e.g., active state or passive state). Each node may be aware of the state and priority of the other nodes in the cluster based on having access to the records on the notice board. Each node may independently determine whether it should stay in its current state or transition to a different state based on its view of the state and priority of other nodes in the cluster, as presented by the notice board. Embodiments may only require that the notice board provide eventual consistency (strong consistency is not required). This relaxed requirement allows many commonly available storage technologies such as networked file systems and eventually consistent databases to be used to implement the notice board. Embodiments are able to gracefully handle failover and switchback scenarios, and require minimal configuration.

An embodiment is a method by a node in a cluster of nodes to support active node selection in the cluster, where each node in the cluster is communicatively coupled to a notice board. The method includes publishing, to the notice board, a record associated with the node that indicates a priority of the node and that indicates that the node is in a passive state, changing a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster, and modifying the record associated with the node on the notice board to indicate that the node is in the active state. The method may further include changing the state of the node from the active state to the passive state in response to a determination, based on a record on the notice board, that another node in the cluster is in the active state and has a higher priority than the node and modifying the record associated with the node on the notice board to indicate that the node is in the passive state. In one embodiment, priority of the node is generated randomly, which helps reduce the amount of configuration required.

Embodiments described herein provide various technological advantages. An advantage of embodiments described herein is that no explicit, direct, node-to-node signaling is needed to determine which node in the cluster is to serve as the active node (i.e., be in the active state). All that is needed to make the correct decision is for each node to have an eventually consistent view of the state and priority of the other nodes in the cluster. Another advantage of embodiments described herein is that they can be implemented using already-existing, reliable, and well-understood platform components. Another advantage of embodiments described herein is that they can be implemented with little to no configuration that is specific to the active node selection process. Another advantage of embodiments described herein is that they use a simpler protocol compared to existing approaches (e.g., compared to existing approaches that use a node-to-node protocol or broadcast messaging protocol), which results in fewer bugs and makes debugging easier when problems occur. While the more complex existing approaches may offer theoretical advantages, they might be less available in practice. Embodiments are now described with reference to the accompanying figures.

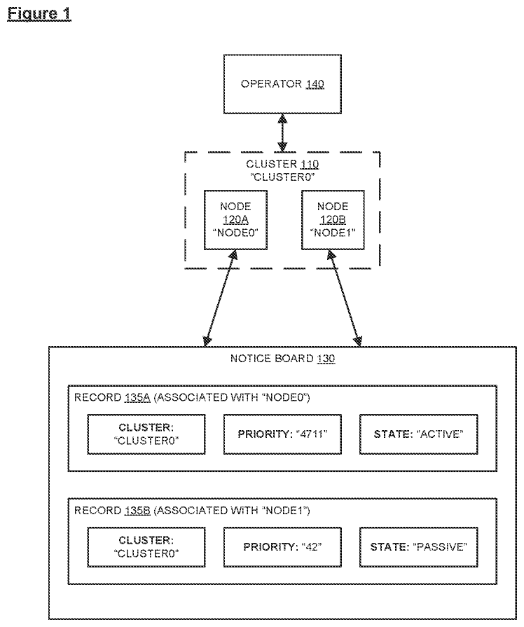

FIG. 1 is a diagram of an environment in which an active node selection process may be performed, according to some embodiments. As shown in the diagram, the environment includes node 120A (“node0”) and node 120B (“node1”), which are members of a cluster 110 (“cluster0”). The cluster 110 may provide a particular service/functionality. Each node 120 in the cluster 110 may be configured to provide the service/functionality of the cluster 110. Each node 120 in the cluster 110 may be in the active state (in which case the node is referred to as being an “active node”) or the passive state (in which case the node is referred to as being a “passive node”). A node that is in the active state actively provides the relevant service/functionality of the cluster 110. A node that is in the passive state does not actively provide the relevant service/functionality of the cluster 110 but is on standby to provide the relevant service/functionality of the cluster 110 in case the active node fails. Each node 120 in the cluster 110 may be communicatively coupled to the notice board 130. The notice board 130 is a storage and/or communication infrastructure that allows nodes 120 to share information among each other. The environment further includes an operator 140 that is communicatively coupled to the cluster 110. The operator 140 is responsible for the configuration and management of the nodes 120. While for the sake of simplicity the figure shows the cluster 110 as only including two nodes 120, it should be understood that the cluster 110 may include more than two nodes. Also, while the figure shows the environment as including a single cluster 110, it should be understood that there can be more than one cluster.

As will be described further herein, the nodes 120 in the cluster 110 may support an active node selection process. The overall aim of the active node selection process is to have exactly one of the available nodes in the cluster 110 to be in the active state (and to have all other nodes in the cluster in the passive state) for as often as possible and to do this in a distributed manner (e.g., without direct node-to-node communications). As used herein, an available node is a node that is both capable of accessing the notice board 130 and able to provide the relevant service/functionality if it is selected to be the active node.

Each node in the cluster 110 may have a priority. For example, node 120A (“node0”) may have a priority of “4711” and node 120B (“node1”) may have a priority of “42”. While embodiments described herein use a number to indicate node priority, where a higher number indicates higher node priority (and a lower number indicates lower node priority), it should be understood that other embodiments may use a different format/convention (as long as the format/convention allows for the ordering and comparison of priorities).

In one embodiment, the priority of a node is preconfigured (e.g., the operator 140 may assign a predetermined unique priority to each node 120 in the cluster 110). In one embodiment, a node 120 randomly generates its priority. If node priority is randomly generated, care should be taken to use a high-quality random number generator (RNG) and to use a large-enough range of possible numbers to reduce the likelihood of a collision with other nodes (e.g., where two or more nodes 120 pick the same number). As will become apparent from the present disclosure, a benefit of randomly generating node priority is that it reduces the amount of configuration required (e.g., there is no need for the operator 140 to assign node priorities). However, this may not allow a higher-level system or system administrator (e.g., the operator 140) to choose which node 120 in the cluster 110 should serve as the active node in cases where there are multiple available nodes 120 in the cluster 110.

In cases where node priority is randomly generated, it is possible to further reduce the risk of two nodes picking the same number by having a node 120 read the notice board 130 to check if the priority it randomly generated is already in use, and if so, to generate another one.

While embodiments are primarily described herein where node priority is randomly generated, it should be understood that the techniques and principles described herein can apply to cases where node priority is not randomly generated (e.g., the operator 140 assigns priorities to the nodes 120), as long as the priorities are unique within a given cluster 110 and can be compared to each other.

In one embodiment, the priority of a node 120 is also used as the node identifier (ID). Other embodiments may have a separation between node ID and node priority. In such embodiments, one or both of the node ID and node priority may be randomly generated (e.g., using a RNG). Embodiments are primarily described herein where the node priority also functions as the node ID (the node priority has a dual role) but it should be understood that the techniques and principles described herein can apply to cases where there is a separation between the node ID and the node priority.

In one embodiment, a node 120 stores its priority in its non-volatile memory so that it can be retrieved in the event of a crash. The active node selection process described herein will still work correctly even if node priority is regenerated when a node 120 reboots (resulting in the node 120 having a different priority than it had before the reboot), but in that case the node 120 may not be able to distinguish its own, previously published, records from the records associated with other nodes. This does not prevent the system from converging to a consistent state, but it may cause the system to take longer to do so.

A node 120 may publish a record to the notice board 130 so that it can be seen by other nodes that have access to the notice board 130. A record may include a set of properties, each having a name and a value. A node 120 may subscribe to the notice board 130 to receive notifications regarding records on the notice board 130. In this regard, the notice board 130 may include a change notification mechanism to notify subscribed nodes regarding changes to records on the notice board 130. For example, the notice board change notification mechanism may send a notification to a subscribed node when a new record is published to the notice board 130, a record is removed from the notice board 130, and/or a record on the notice board 130 is modified. The notification may include information about the relevant record and the change that was made (e.g., addition, removal, or modification). A node 120 may set a filter when subscribing to the notice board 130 to only receive notifications regarding certain records that the node is interested in (e.g., filter out notifications regarding records that the node 120 is not interested in). The change notification mechanism of the notice board 130 is an example of a “push” mechanism. Some embodiments may instead use a “pull” mechanism where the node 120 pulls records from the notice board 130. In one embodiment, the notice board 130 includes a mechanism to detect when a node has been disconnected from the notice board 130 (e.g., because the node 120 crashed or lost network connectivity to the notice board 130). In one embodiment, the notice board 130 removes a record if it determines that the node 120 associated with that record (e.g., the node that initially published that record to the notice board 130) has been disconnected from the notice board 130 for longer than a threshold length of time. This threshold length of time may be referred to herein as the record time-to-live (TTL).

In one embodiment, the notice board 130 has the following properties: (1) it allows nodes to publish records to the notice board and read records on the notice board; (2) it allows naming of records; (3) the same name space with the same records are available to all nodes; (4) it is reliable enough not to be a liability to the active node selection process; (5) it supports eventual consistency or stronger consistency (but does not necessarily have to support the level of consistency of a relational database).

As an example, the notice board 130 may be implemented using a distributed, highly available network file system or disk block device presented in the form of a Kubernetes Persistent Volume (PV). As another example, the notice board 130 may be implemented using a distributed, highly available, in-memory key-value database, such as Redis. As another example, the notice board 130 may be implemented using a system for client-side service discovery such as the Pathfinder service discovery system.

In one embodiment, each node 120 maintains the follow information: (1) cluster ID—the identifier of the cluster 110 of which the node is a member (no two clusters may have the same identifier); (2) priority-a number that is unique to the node within a cluster (as mentioned above, it may be used simultaneously as a node ID and as a priority); and (3) state—the current state of the node, which may be the active state or the passive state.

In one embodiment, a node 120 follows the following rules: (1) all records on the notice board 130 indicating the same cluster 110 as the node 120 but a different priority is treated as if published by another node in same cluster 110; and (2) notifications received for current or stale records indicating the same priority as the node 120 are ignored.

In one embodiment, a node 120 supports the active node selection process in the manner described below. When the 120 node starts up, the node 120 may retrieve its priority from non-volatile memory (if the priority was previously stored in non-volatile memory) or randomly generate its priority and store it in non-volatile memory. In the example shown in the diagram, it is assumed that node 120A has a priority of “4711” and node 120B has a priority of “42”. The node 120 may also determine which cluster 110 it is a member of. For example, node 120A and node 120B may both determine that they are members of the cluster 110 named “cluster0”. The operator 140 may have assigned the nodes 120 to the cluster 110.

When a node 120 first starts up it is in the passive state. The node 120 may publish a record to the notice board 130 to indicate that the node 120 is in the passive state. In one embodiment, a record includes a cluster property to indicate the cluster that the node belongs to, a priority property to indicate the priority of the node with regard to active node selection process (which may also serve as the node ID), and a state property to indicate the current state of the node. A record containing information pertaining to a particular node 129 may be referred to herein as being associated with that node 120.

The node 120 may also subscribe to the notice board 130 to be notified of records associated with other nodes in the same cluster 110 as the node 120. The node 120 may then wait for some time to allow its record to propagate through the notice board 130 and to the other nodes in the same cluster 110, and also to receive any relevant notifications regarding already-existing or recently published records associated with other nodes in the same cluster 110. In one embodiment, the node 120 waits for a predefined timeout length (e.g., 10 seconds) to allow for propagation of records between the nodes, via the notice board 130. In one embodiment, if the node 120 knows how many total nodes are in the cluster 110 then the node 120 does not need to wait for the full timeout length if it receives notifications regarding the records associated with all of the other nodes in the cluster before the timeout length expires. For example, if node 120A knows that there is only one other node in the cluster 110 (node 120B), then node 120A does not need to wait for the full timeout length if it receives a notification regarding the record associated with the other node before the timeout length expires.

If the node 120 is in the passive state (as it is when it first starts up) and determines either (1) that there are no other available nodes in the cluster; or (2) that all of the other available nodes in the same cluster 110 are in the passive state and the node 120 has the highest priority among them then the node 120 changes its state from the passive state to the active state. The node 120 may then modify its record on the notice board 130 to indicate that it is now in the active state.

If the node 120 is in the active state and determines that there is another node in the same cluster 110 that is in the active state and that has a higher priority, then the node 120 changes its state from the active state to the passive state. The node 120 may then modify its record on the notice board 130 to indicate that it is now in the passive state.

The figure shows a system steady state in which node 120A is in the active state and node 120B is in the passive state and the records on the notice board 130 reflect this. For example, the notice board includes a record 135A (associated with node 120A) that indicates that node 120A is in the active state and a record 135B (associated with node 120B) that indicates that node 120B is in the passive state. Specifically, record 135A includes a cluster property having a value of “cluster0”, a priority property having a value of “4711”, and a state property having a value of “active” and record 135B includes a cluster property having a value of “cluster0”, a priority property having a value of “42”, and a state property having a value of “passive”.

Embodiments described herein assume that the nodes 120 and any other entities that publish records to the notice board 130 are benign and behave according to protocol. That is, a node 120 may crash/fail but a failure scenario in which it inaccurately describes itself as being in the active state when it is actually in the passive state or vice versa, or publishes a record indicating a node ID/priority which is used by some other node in the cluster 110 or some other cluster is not addressed. Such a failure could be due to malicious intent or a software fault.

In one embodiment, node priority may be configured/assigned to reflect a preference to keep a particular node in the active state. For example, preference may be given to node 120A by configuring node 120A to have a higher priority than node 120B.

In one embodiment, switchback (after a failover) of the active node from a lower priority node to a higher priority node is initiated by causing the active lower priority node to go into the passive state. This will cause the passive higher priority node to become the active node. In one embodiment, a “targeted” switch back may be supported by manipulating priorities. In principle, a node can change its priority during its lifetime. A node 120 that is in the active state can lower its priority so that it no longer has the highest priority in the cluster 110 and then if there is another node presented with a higher priority, change its state to the passive state and modify its record on the notice board 130 to reflect this. This will cause the other node (which now has a higher priority) to change its state to the active state. Also, a passive node may change its priority to have the highest priority in the cluster and thus when the currently active node fails or the operator 140 causes the currently active node to change its state to the passive state, the passive node will then change its state to the active state.

In one embodiment, to support node priority changes and to allow node priorities to be centered in the lower value range, an extra property in the publishing can be used to initiate “re-randomization” of priority in all connected nodes (since one node is in the active state, no change of active node will occur). In one embodiment, nodes can be divided into different sets, where all nodes in a given set have either higher or lower priorities than the nodes in another set (this allows, for example, for creating a set of preferred standby nodes and last resort standby nodes). Another way to achieve switchback (after a failover) is to have the currently active lower priority node unpublish its service for long-enough time for the higher priority node to take over as the active node, after which the lower priority node may publish its record on the notice board 130 again (now in the passive state).

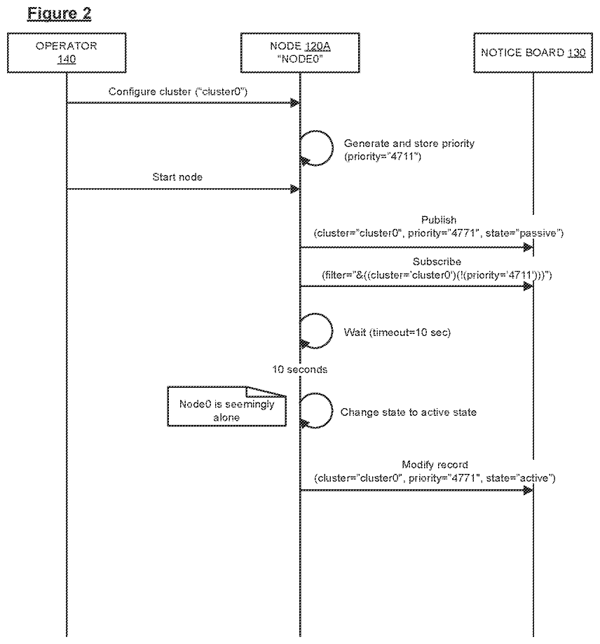

Various sequences of operations are shown in FIGS. 2-6 and described herein below to further illustrate the embodiments.

FIG. 2 is a sequence diagram illustrating a node starting up and going active, according to some embodiments. The sequences shown in this figure and other figures assume that the notice board is implemented using the Pathfinder service discovery system. As such, the sequences shown in the figures and described herein use a Pathfinder filter syntax (which resembles the Lightweight Directory Access Protocol (LDAP) filter syntax). For example, the filter “(&(p0=v0) (!(p1=v1)))” means that the filter matches records which include a property having the name “p0” and the value “v0” and that do not include a property having the name “p1” and the value “v1”. The sequences assume that the timeout length for waiting is ten seconds. Other embodiments may use a different timeout length. This timeout length can be tuned based on the expected latency of the notice board 130 and the time it takes for the notice board 130 to detect a disconnected node.

As shown in the figure, the operator 140 configures node 120A (“node0”) to be a member of the cluster named “cluster0” (“Configure cluster (‘cluster0’)”). Node0 randomly generates and stores its priority in its non-volatile memory. In this example, the randomly generated priority is “4711”. The operator 140 then configures node0 to start up (“Start node”). At start up, node0 publishes a record to the notice board 130 indicating that it is in a passive state. In this example, the record includes a cluster property having a value of “cluster0”, a priority property having a value of “4711”, and a state property having a value of “passive”. Node0 also subscribes to the notice board 130 to receive notifications regarding records associated with other nodes in the same cluster. In this example, node0 subscribes to the notice board 130 with a filter set to “&((cluster=‘cluster0’) (!(priority=‘4711’)))” (e.g., to receive notifications regarding records including a cluster property having a value of “cluster0” and that do not include a priority property having a value of “4711”). Node0 waits for a timeout length of ten seconds and does not receive any notifications from the notice board 130, and thus determines that it is the only available node in the cluster 110. As such, node0 changes its state from the passive state to the active state. Node0 then modifies its record on the notice board 130 to indicate that it is now in the active state (e.g., changes the value of the state property of the record associated with node0 from “passive” to “active”).

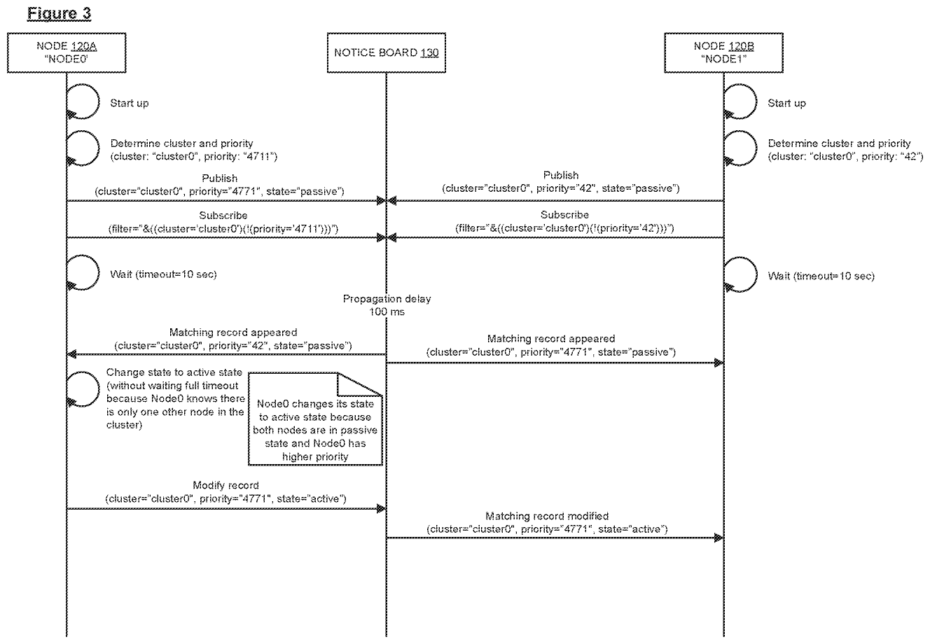

FIG. 3 is a sequence diagram illustrating two nodes starting up simultaneously (or almost simultaneously) and agreeing on which one should go active, according to some embodiments.

As shown in the figure, node 120A (“node0”) and node 120B (“node1”) start up simultaneously or almost simultaneously. Node0 determines its cluster (“cluster0”) and priority (“4711”). Node1 also determines its cluster (“cluster0”) and priority (“42”). In this example, both node0 and node1 are members of the same cluster (“cluster0”) and node0 has a higher priority than node1. Node0 publishes a record to the notice board indicating that it is in the passive state. This record includes a cluster property having a value of “cluster0”, a priority property having a value of “4711”, and a state property having a value of “passive”. Node1 also publishes a record to the notice board indicating that it is in the passive state. This record includes a cluster property having a value of “cluster0”, a priority property having a value of “42”, and a state property having a value of “passive”. Node0 subscribes to the notice board 130 to receive notifications regarding records associated with other nodes in the same cluster. In this example, node0 subscribes to the notice board 130 with a filter set to “&((cluster=‘cluster0’) (!(priority=‘4711’)))” (e.g., to receive notifications regarding records including a cluster property having a value of “cluster0” and that do not include a priority property having a value of “4711”). Node1 also subscribe to the notice board 130 to receive notifications regarding records associated with other nodes in the same cluster. In this example, node1 subscribes to the notice board 130 with a filter set to “&((cluster=‘cluster0’) (!(priority=‘42’)))” (e.g., to receive notifications regarding records including a cluster property having a value of “cluster0” and that do not include a priority property having a value of “42”). Node0 and node1 both begin waiting with a timeout length of ten seconds. In this example, after about a 100 milliseconds propagation delay, node0 receives a notification from the notice board 130 that there is a matching record (a record that matches the filter set by node0). The matching record includes a cluster property having a value of “cluster0”, a priority property having a value of “42”, and a state property having a value of “passive”. Node0 may determine based on this notification that the only other node in the cluster is also in the passive state and has a lower priority, and thus determines that it should change its state from the passive state to the active state. As a result, node0 changes its state from the passive state to the active state. Node0 then modifies its record on the notice board 130 to indicate that it is now in the active state (e.g., changes the value of the state property of the record associated with node0 from “passive” to “active”). It should be noted that this sequence assumes that node0 knows that the cluster only includes two nodes. Thus, node0 can make the determination to change its state from the passive state to the active state without waiting for the full timeout length of ten second once it has received information about the other node.

Around the same time that node0 receives a notification from the notice board 130 that there is a matching record, node1 may also receive a notification from the notice board 130 that there is a matching record (a record that matches the filter set by node1). The matching record includes a cluster property having a value of “cluster0”, a priority property having a value of “4771”, and a state property having a value of “passive”. Node1 may determine based on this notification that there is another node in the cluster that is also in the passive state but has a higher priority, and thus determine that it should remain in the passive state.

As mentioned above, this sequence assumes that both nodes 120 know that they belong to a cluster that includes two nodes. The sequence may be slightly different if the cluster includes more than two nodes and/or if the number of nodes in the cluster is open ended (e.g., the number of nodes in the cluster is not preconfigured or known). In this case, for example, node0 may, to allow for slow state propagation through the notice board 130 and possible transient network issues, not change its state to the active state until it has waited for the full timeout length of ten seconds.

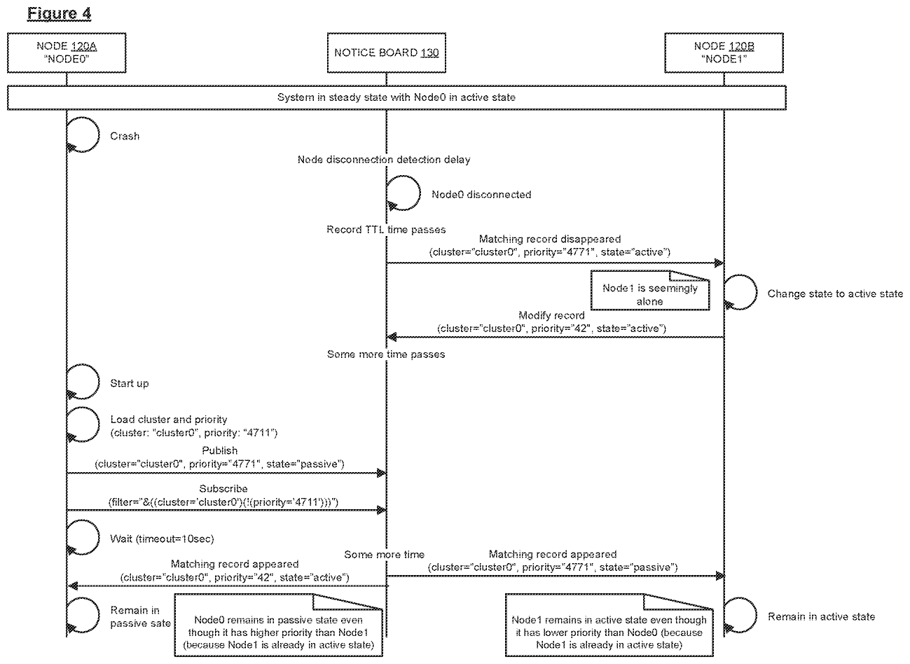

FIG. 4 is a sequence diagram illustrating a failover scenario, according to some embodiments.

As shown in the figure, the system is initially in a steady state with node 120A (“node0”) in the active state and node 120B (“node1”) in the passive state. Subsequently, node0 crashes and the notice board 130 detects this after a node disconnection detection delay. After a record TTL time passes, node1 receives a notification from the notice board 130 that a matching record has disappeared. The record that disappeared is the record that included a cluster property having a value of “cluster0”, a priority property having a value of “4771”, and a state property having a value of “active” (this is the record associated with node0). Node1 determines based on this notification that it is seemingly alone in the cluster and thus changes its state from the passive state to the active state. Node1 then modifies its record on the notice board 130 to indicate that it is now in the active state (e.g., changes the value of the state property of the record associated with node1 from “passive” to “active”).

After some more time passes, node0 starts up and determines its cluster (“cluster0”) and priority (“4711”). Node0 publishes a record to the notice board 130 indicating that it is in the passive state. This record includes a cluster property having a value of “cluster0”, a priority property having a value of “4711”, and a state property having a value of “passive”. Node0 also subscribes to the notice board 130 to receive notifications regarding records associated with other nodes in the same cluster. In this example, node0 subscribes to the notice board 130 with a filter set to “&((cluster=‘cluster0’) (!(priority=‘4711’)))” (e.g., to receive notifications regarding records including a cluster property having a value of “cluster0” and that do not include a priority property having a value of “4711”). Node0 then begins waiting with a timeout length of ten seconds. In this example, after some time passes, node0 receives a notification from the notice board 130 that there is a matching record (a record that matches the filter set by node0). The matching record includes a cluster property having a value of “cluster0”, a priority property having a value of “42”, and a state property having a value of “passive” (this is the record associated with node1). Node0 may determine based on this notification that there is another node in the cluster that has a lower priority. However, node0 decides to remain in the passive state even though it has a higher priority because node1 is already in the active state.

Sometime after node1 publishes its record to the notice board 130, node1 receives a notification from the notice board 130 regarding this record. This record includes a cluster property having a value of “cluster0”, a priority property having a value of “4711”, and a state property having a value of “passive”. Node1 determines based on this notification that there is another node in the cluster that has a higher priority and that is in the passive state. However, node1 remains in the active state even though it has lower priority because it is already in the active state.

Thus, in this sequence, when the active node (node0) crashes, the passive node (node1) takes over as the active node and remains in the active state even after the originally active node (node0) restarts and is available to take over.

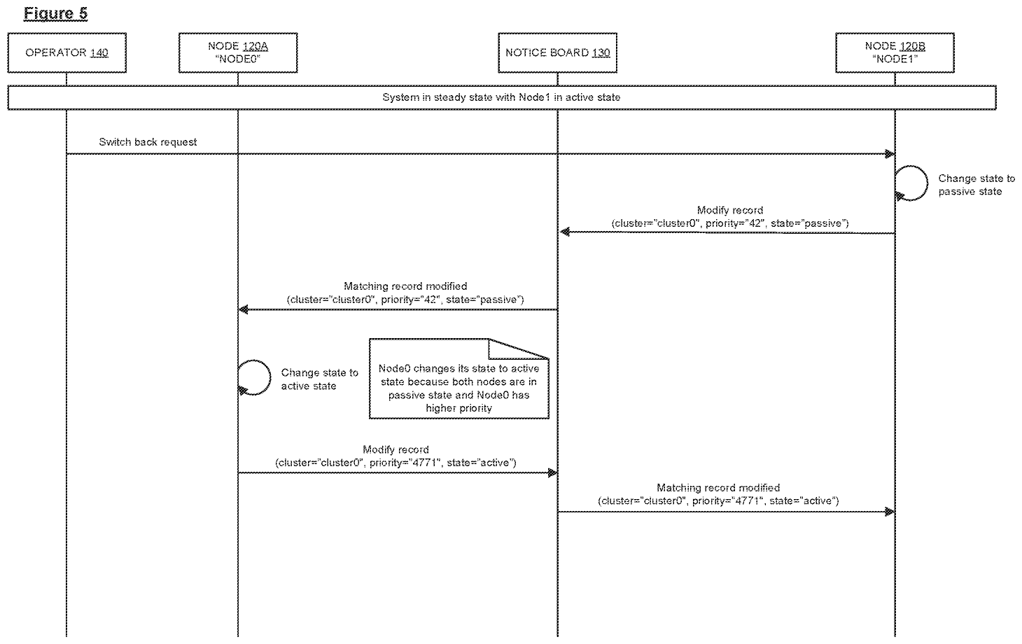

FIG. 5 is a sequence diagram illustrating an operator-initiated switchback, according to some embodiments.

As shown in the figure, the system is initially in a steady state with node 120B (“node1”) in the active state and node 120A (“node0”) in the passive state. The operator 140 sends a switchback request to node1. In response to receiving the switchback request, node1 changes its state from the active state to the passive state and modifies its record on the notice board 130 to indicate that it is now in the passive state (e.g., changes the value of the state property of the record associated with node1 from “active” to “passive”).

Subsequently, node0 receives a notification from the notice board 130 indicating that a matching record has been modified. The modified record includes a cluster property having a value of “cluster0”, a priority property having a value of “42”, and a state property having a value of “passive” (this is the record associated with node1). Node0 determines based on this notification that it should change its state from the passive state to the active state because both itself and node1 are in the passive state but it has higher priority than node1. Thus, node0 changes its state from the passive state to the active state and modifies its record on the notice board 130 to indicate that it is now in the active state (e.g., changes the value of the state property of the record associated with node0 from “passive” to “active”).

Node1 then receives a notification from the notice board indicating that a matching record has been modified. The modified record includes a cluster property having a value of “cluster0”, a priority property having a value of “4711”, and a state property having a value of “active” (this is the record associated with node0). Node1 determines based on this notification to remain in the passive state.

Thus, in this sequence, an operator initiates switchback from a lower priority node (node 1) to the highest priority node (node0) by causing the lower priority node to go passive. In another embodiment, switchback may be supported without operator intervention. For example, in the example above, node1 may change its state from the active state to the passive state in response to a determination that there is another node in the cluster that is in the passive state and that has a higher priority than itself (instead of doing so in response to receiving a switchback request from the operator 140). This will cause node0 to become the active node in a similar manner as described above. This type of switchback may be useful in situations where there is a preference for a particular node to be the active node (e.g., the operator 140 can assign the highest priority to the preferred node).

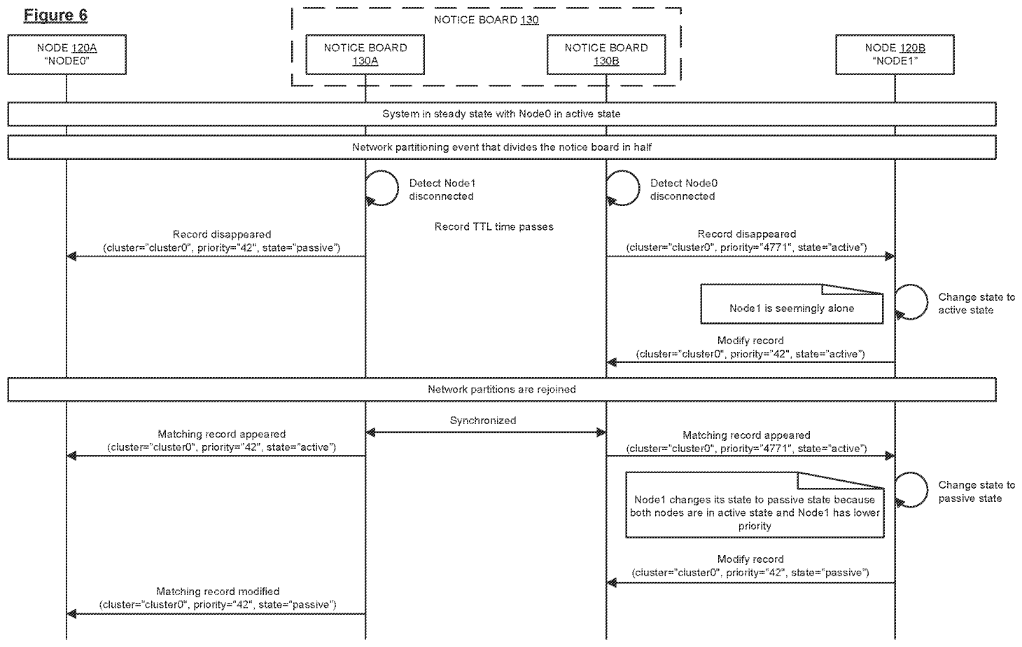

FIG. 6 is a sequence diagram illustrating a network outage induced inconsistency, according to some embodiments.

As shown in the figure, the system is initially in a steady state with node 120A (“node0”) in the active state and node 120B (“node1”) in the passive state. Subsequently, a network partitioning event occurs that divides the notice board 130 in half such that there is a first part 130A that is accessible to node0 but not accessible to node1 and a second part 130B that is accessible to node1 but not accessible to node0.

As a result of the partitioning event, the first part of the notice board 130A detects that node1 has disconnected. After a record TTL time passes, node0 receives a notification from the first part of the notice board 130A that a matching record has disappeared. The record that disappeared included a cluster property having a value of “cluster0”, a priority property having a value of “42”, and a state property having a value of “passive” (this is the record associated with node1). Similarly, as a result of the partitioning event, the second part of the notice board 130B detects that node0 has disconnected. After the record TTL time passes, node1 receives a notification from the second part of the notice board 130B that a matching record has disappeared. The record that disappeared included a cluster property having a value of “cluster0”, a priority property having a value of “4711”, and a state property having a value of “active” (this is the record associated with node0). Node1 determines based on this notification that it is seemingly alone in the cluster and thus changes its state from the passive state to the active state and modifies its record on the notice board 130 to indicate that it is now in the active state (e.g., changes the value of the state property of the record associated with node1 from “passive” to “active”).

Subsequently, the network partitions are rejoined and the notice board is synchronized. As a result, node0 receives a notification from the notice board 130 that a matching record has appeared. The matching record includes a cluster property having a value of “cluster0”, a priority property having a value of “42”, and a state property having a value of “active” (this is the record associated with node1). Node0 determines based on this notification that it should remain in the active state because it has higher priority. Also, node1 receives a notification from the notice board 130 that a matching record has appeared. The matching record includes a cluster property having a value of “cluster0”, a priority property having a value of “4711”, and a state property having a value of “active”. Node1 determines based on this notification that it should change its state from the active state to the passive state because both itself and node0 are in the active state but it has lower priority. Thus, node1 changes its state from the active state to the passive state and modifies its record on the notice board 130 to indicate that it is now in the passive state (e.g., changes the value of the state property of the record associated with node1 from “active” to “passive”). Node0 then receives a notification from the notice board 130 indicating that a matching record has been modified. The modified record includes a cluster property having a value of “cluster0”, a priority property having a value of “42”, and a state property having a value of “passive” (this is the record associated with node1). Node0 determines based on this notification to remain in the active state because node1 is in the passive state (and it has higher priority than node1).

Thus, in this sequence, a network partitioning event occurs that divides the notice board into two parts (a so-called “split brain” scenario), which causes a state of inconsistency where there are two active nodes in the cluster. However, the system automatically returns to a steady state (with only one active node) when the network partitions are rejoined and the notice board 130 is synchronized.

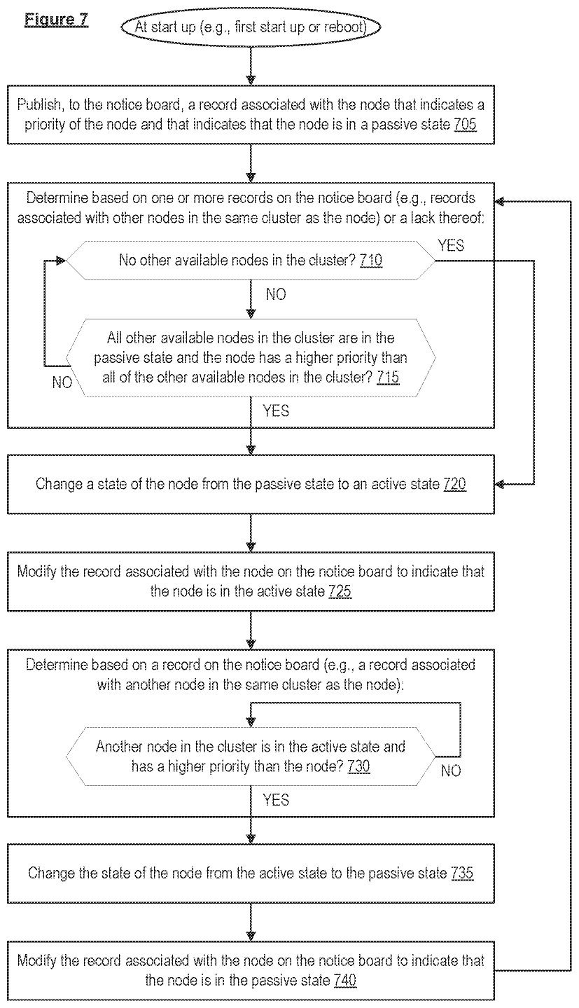

FIG. 7 is a flow diagram of a method for supporting active node selection in a cluster of nodes, according to some embodiments. In one embodiment, the method is implemented by one or more computing devices implementing a node in the cluster, where each node in the cluster is communicatively coupled to a notice board. The method may be implemented using hardware, software, firmware, or any combination thereof.

The operations in the flow diagram will be described with reference to the exemplary embodiments of the other figures. However, it should be understood that the operations of the flow diagram can be performed by embodiments other than those discussed with reference to the other figures, and the embodiments discussed with reference to these other figures can perform operations different than those discussed with reference to the flow diagram.

The method begins when a node starts up (e.g., first boot up or a reboot).

At block 705, the node publishes, to the notice board, a record associated with the node that indicates a priority of the node and that indicates that the node is in a passive state. In one embodiment, the node (randomly) generates the priority of the node using a random number generator. In one embodiment, the node stores the priority of the node in a non-volatile memory of the node and retrieves the priority of the node from the non-volatile memory of the node after a reboot of the node. In one embodiment, the priority of the node also functions as an identifier of the node. In one embodiment, the notice board is implemented using an eventually consistent data store (e.g., the Pathfinder service discovery system).

In one embodiment, the node subscribes to the notice board to receive notifications regarding appearances of new records on the notice board, modifications to existing records on the notice board, and disappearances of records from the notice board.

In one embodiment, the node determines, based on a record on the notice board while the node is in the passive state, that another node in the cluster is in the active state, wherein the another node has a lower priority than the node. In response, the node may remain in the passive state despite the another node having a lower priority than the node (e.g., to allow the another node to stay in the active state until it crashes/fails).

The decisions of decision blocks 710 and 715 are made based on one or more records on the notice board (e.g., records associated with other nodes in the same cluster as the node) or a lack thereof. At decision block 710, the node determines whether there are no other available nodes in the cluster. If so, the method moves to block 720. Otherwise, at decision block 715, the node determines whether all other available nodes in the cluster are in the passive state and the node has a higher priority than all of the other available nodes in the cluster. If so, the method moves to block 720. Otherwise, the method moves back to decision block 710.

In one embodiment, the determination that there are no other available nodes in the cluster is based on not receiving any notifications from the notice board for a predetermined timeout length after subscribing to the notice board. In one embodiment, the determination that there are no other available nodes in the cluster is based on receiving notifications from the notice board indicating that records associated with all other nodes in the cluster have disappeared from the notice board. In one embodiment, the determination that all of the other available nodes in the cluster are in the passive state and the node has a higher priority than all of the other available nodes in the cluster is made based on receiving notifications from the notice board regarding records associated with all other nodes in the cluster without waiting for a predetermined timeout length.

At block 720, the node changes a state of the node from the passive state to the active state and at block 725, modifies the record associated with the node on the notice board to indicate that the node is in the active state.

In one embodiment, the node receives, from an operator, a request to change the state of the node from the active state to the passive state, changes the state of the node from the active state to the passive state in response to receiving the request, and modifies the record associated with the node on the notice board to indicate that the node is in the passive state, wherein the record associated with the node on the notice board being modified to indicate that the node in the passive state causes a state of another node in the cluster that has a higher priority than the node to change from the passive state to the active state (for an operator-initiated switchback). In one embodiment, the node changes the state of the node from the active state to the passive state in response to a determination, based on a record on the notice board, that another node in the cluster is in the passive state and has a higher priority than the node and modifies the record associated with the node on the notice board to indicate that the node is in the passive state, wherein the record associated with the node on the notice board being modified to indicate that the node in the passive state causes a state of the another node to change from the passive state to the active state (for a switchback without operator intervention). This approach (and the previously described operator-initiated switchback approach) may be particularly suitable for embodiments where the priority of the node is assigned by an operator (to reflect the node preference of the operator). In one embodiment, the node determines, based on a record on the notice board while the node is in the active state, that another node in the cluster is in the passive state, wherein the another node has a higher priority than the node and remains in the active state despite the another node having a higher priority than the node. This approach may be particularly suitable for embodiments where the priority of the node is generated randomly (using a RNG) and there is no particular preference for which node should be the active node.

The decision of decision block 730 is made based on a record on the notice board (e.g., a record associated with another node in the same cluster as the node). At decision block 730, the node determines whether another node in the cluster is in the active state and has a higher priority than the node. If not, the method moves back to decision block 730. Otherwise, at block 735, the node changes the state of the node from the active state to the passive state and at block 740, modifies the record associated with the node on the notice board to indicate that the node is in the passive state. The method then moves back to decision block 710.

As mentioned above, the notice board 130 may be implemented using a variety of existing tools. In one embodiment, the notice board 130 is implemented using the Pathfinder service discovery system (simply referred to as “Pathfinder”). Pathfinder is a distributed, highly available, eventually consistent service discovery system. A Pathfinder domain is served by one or more Pathfinder server instances. A Pathfinder client is typically either an application providing some sort of service (a “producer”), or an application which depend on some kind of service for its operation (a “consumer”). Pathfinder may however be used for other purposes, which is the case for embodiments described herein.

The core of Pathfinder's data model is the service record. The service record is a list of arbitrary, client-supplied, key-value pairs. The service records reside in a Pathfinder domain. A Pathfinder domain may have nothing to do with its domain name service (DNS) namesake.

A Pathfinder client may publish service records or modify already-existing records. Pathfinder allows a client to issue a subscription, with an optional filter. The Pathfinder servers serving the domain will attempt to find any service records matching the filter. For each match, a notification will be fed back to the client. In addition, Pathfinder will notify clients if a previously matched record is being modified or removed. This process may continue for as long as the subscription is active.

Pathfinder is eventually consistent in the sense that if a service is published, there is no guarantee that the service record is immediately seen by all clients with matching subscriptions. However, barring any permanent outages (network or server outages), all clients will eventually see a particular change.

In Pathfinder, changes to service records are atomic. Another guarantee is that a series of changes to a particular service will appear to the clients in the order they are made, although some changes may be emitted (“squashed”).

A useful feature of Pathfinder for that embodiments may leverage is its “liveness” tracking and TTL mechanism. A Pathfinder server may monitor all connected clients. In case a client has crashed, or if the client-server network connectivity is lost, the server may mark all services published by this lost client as “orphans”. At the time of publication, the client may supply a TTL value (in seconds) for the service record. This value species how long of a time a record is to be considered usable, even though it is an orphan. When a service record has been in the orphan state for longer time than the TTL time, it is removed, and all clients with matching subscriptions may be notified of this fact. In case a Pathfinder client owning a particular service reconnects before the service's TTL has expired, the orphan classification is removed. Thus, a short network outage or a quick restart can be masked with an appropriately crafted TTL setting. With embodiments described herein TTL may govern how quickly the failover will occur.

In one embodiment, the notice board 130 is implemented using a distributed file system (or a network file system). A directory tree of this file system may be made available to all participating nodes in a cluster. In one embodiment, if this directory is private to the cluster, then the cluster property need not be included in file data or meta data.

The publish operation will mean writing the state and priority to the shared directory, in the form of a file. One potential mapping is to give a node's file the name of the value of its priority, and the contents of the file is its state. Measures should be taken to assure that writing/modifying the file is done in atomic manner. If the distributed file system does not leave any such guarantees, the writer may include a hash in the contents (e.g., if the file system doesn't have the guarantee), so that the reader can verify the file data is internally consistent (and re-read the file if it is not).

The equivalent of the subscribe operation may be implemented by listing all files in the shared directory. The node stores the results of the previous scan to be able to produce the Pathfinder-style behavior toward higher layers.

At initial startup, the node would consider all files with a too-old time stamp (higher than TTL, see below) as stale. All other files (except the node's own file) are to be considered the equivalent of an “appeared” subscription notification. Files which data (disregarding any potential time stamp) have changed since the last scan, should yield a “modified” notification. Files which are removed (since the previous scan), or which time stamps are older than the configured “TTL” (see below) should yield a “removed” notification. An alternative to a periodic “poll” of the directory, is to use file system monitoring facility like Linux's inotify sub system to detect changes.

One method for a node to track the liveness of the other nodes is to use time stamps in on/in the files in the shared directory. This method requires that the real-time clocks of the nodes are reasonably synchronized. Each node periodically updates a time stamp in/on its file periodically. Each node periodically checks timestamps of all other nodes' files in the directory. For a distributed file system with The Portable Operating System Interface (POSIX) semantics, the “mtime” meta data field may be used as the timestamp. Another approach is to include the timestamp in the file data. In a manner similar to how Pathfinder TTL mechanism works, the node may detect a peer node being unavailable, when it repeatedly has failed to update its time stamp. The time stamp update period should be substantially shorter than the “TTL” time.

The active node selection process/protocol described herein may not be race free in the sense that it may lead to transient conditions where there are one or more available nodes, but no node is active, or there are multiple available nodes, and more than one of them are active. The system will eventually become consistent, but such periods need to be handled in an as-graceful-as-possible manner.

One way to handle multiple active nodes gracefully is to use some other means for a node becoming active of detecting an already-active node in the cluster. Such channels (out-of-band to notice board-based signaling) can be used to determine if it is appropriate for a node which is transiting to the active state. If such information is used to determine if the node will go active at all (and thus what it publishes in its notice board record), care should be taken to avoid scenarios where the system will never converge to a consistent state.

One robust and simple method is to indeed go to active state and wait until the out-of-band information suggests it is safe to become operational. Another, potentially complementary, robust and simple method is to introduce a delay between a node declaring itself being in the active state and actually going operational. The waiting time allows for detection of another node which simultaneously declared itself as being in the active state. If this happens, the node may declare itself to be in the passive state and wait a random time (possible random interval derived from a unique value such as node priority). After the timeout expires, the node may assess the situation and depending on the circumstances go active again and repeat the procedure.

The behavior of the system if two or more nodes become operational at the same time will determine method to use. That is, if this is something that must really be avoided or if it is sufficient to just eventually get into correct states.

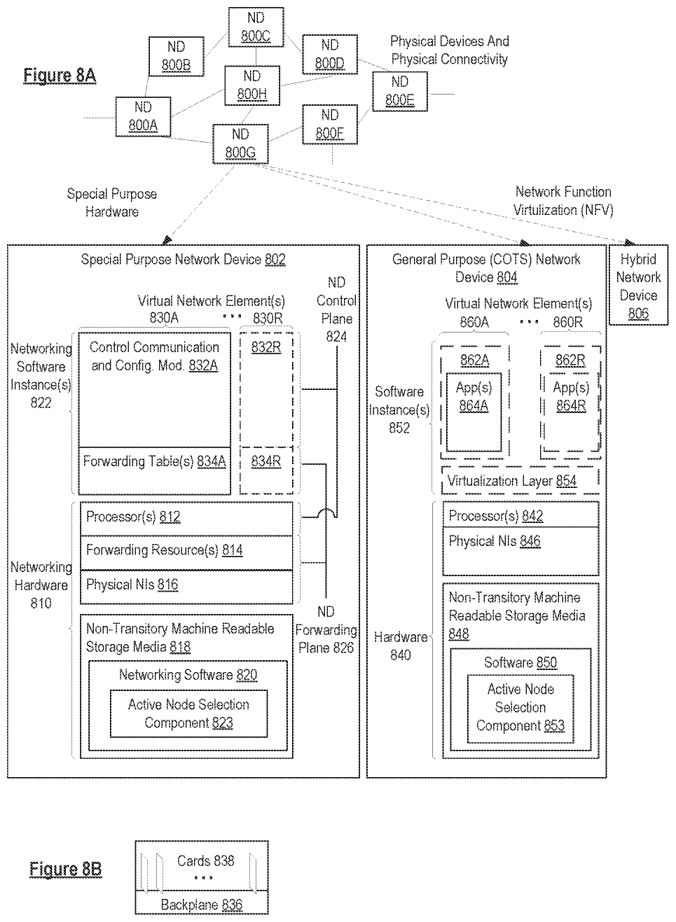

FIG. 8A illustrates connectivity between network devices (NDs) within an exemplary network, as well as three exemplary implementations of the NDs, according to some embodiments. FIG. 8A shows NDs 800A-H, and their connectivity by way of lines between 800A-800B, 800B-800C, 800C-800D, 800D-800E, 800E-800F, 800F-800G, and 800A-800G, as well as between 800H and each of 800A, 800C, 800D, and 800G. These NDs are physical devices, and the connectivity between these NDs can be wireless or wired (often referred to as a link). An additional line extending from NDs 800A, 800E, and 800F illustrates that these NDs act as ingress and egress points for the network (and thus, these NDs are sometimes referred to as edge NDs; while the other NDs may be called core NDs).

Two of the exemplary ND implementations in FIG. 8A are: 1) a special-purpose network device 802 that uses custom application-specific integrated-circuits (ASICs) and a special-purpose operating system (OS); and 2) a general purpose network device 804 that uses common off-the-shelf (COTS) processors and a standard OS.

The special-purpose network device 802 includes networking hardware 810 comprising a set of one or more processor(s) 812, forwarding resource(s) 814 (which typically include one or more ASICs and/or network processors), and physical network interfaces (NIs) 816 (through which network connections are made, such as those shown by the connectivity between NDs 800A-H), as well as non-transitory machine readable storage media 818 having stored therein networking software 820. During operation, the networking software 820 may be executed by the networking hardware 810 to instantiate a set of one or more networking software instance(s) 822. Each of the networking software instance(s) 822, and that part of the networking hardware 810 that executes that network software instance (be it hardware dedicated to that networking software instance and/or time slices of hardware temporally shared by that networking software instance with others of the networking software instance(s) 822), form a separate virtual network element 830A-R. Each of the virtual network element(s) (VNEs) 830A-R includes a control communication and configuration module 832A-R (sometimes referred to as a local control module or control communication module) and forwarding table(s) 834A-R, such that a given virtual network element (e.g., 830A) includes the control communication and configuration module (e.g., 832A), a set of one or more forwarding table(s) (e.g., 834A), and that portion of the networking hardware 810 that executes the virtual network element (e.g., 830A).

In one embodiment software 820 includes code such as active node selection component 823, which when executed by networking hardware 810, causes the special-purpose network device 802 to perform operations of one or more embodiments as part of networking software instances 822 (e.g., to support active node selection in a cluster, as described herein above).

The special-purpose network device 802 is often physically and/or logically considered to include: 1) a ND control plane 824 (sometimes referred to as a control plane) comprising the processor(s) 812 that execute the control communication and configuration module(s) 832A-R; and 2) a ND forwarding plane 826 (sometimes referred to as a forwarding plane, a data plane, or a media plane) comprising the forwarding resource(s) 814 that utilize the forwarding table(s) 834A-R and the physical NIs 816. By way of example, where the ND is a router (or is implementing routing functionality), the ND control plane 824 (the processor(s) 812 executing the control communication and configuration module(s) 832A-R) is typically responsible for participating in controlling how data (e.g., packets) is to be routed (e.g., the next hop for the data and the outgoing physical NI for that data) and storing that routing information in the forwarding table(s) 834A-R, and the ND forwarding plane 826 is responsible for receiving that data on the physical NIs 816 and forwarding that data out the appropriate ones of the physical NIs 816 based on the forwarding table(s) 834A-R.

FIG. 8B illustrates an exemplary way to implement the special-purpose network device 802 according to some embodiments. FIG. 8B shows a special-purpose network device including cards 838 (typically hot pluggable). While in some embodiments the cards 838 are of two types (one or more that operate as the ND forwarding plane 826 (sometimes called line cards), and one or more that operate to implement the ND control plane 824 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 836 (e.g., a first full mesh coupling the line cards and a second full mesh coupling all of the cards).

Returning to FIG. 8A, the general purpose network device 804 includes hardware 840 comprising a set of one or more processor(s) 842 (which are often COTS processors) and physical NIs 846, as well as non-transitory machine readable storage media 848 having stored therein software 850. During operation, the processor(s) 842 execute the software 850 to instantiate one or more sets of one or more applications 864A-R. While one embodiment does not implement virtualization, alternative embodiments may use different forms of virtualization. For example, in one such alternative embodiment the virtualization layer 854 represents the kernel of an operating system (or a shim executing on a base operating system) that allows for the creation of multiple instances 862A-R called software containers that may each be used to execute one (or more) of the sets of applications 864A-R; where the multiple software containers (also called virtualization engines, virtual private servers, or jails) are user spaces (typically a virtual memory space) that are separate from each other and separate from the kernel space in which the operating system is run, and where the set of applications running in a given user space, unless explicitly allowed, cannot access the memory of the other processes. In another such alternative embodiment the virtualization layer 854 represents a hypervisor (sometimes referred to as a virtual machine monitor (VMM)) or a hypervisor executing on top of a host operating system, and each of the sets of applications 864A-R is run on top of a guest operating system within an instance 862A-R called a virtual machine (which may in some cases be considered a tightly isolated form of software container) that is run on top of the hypervisor-the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 840, directly on a hypervisor (in which case the unikernel is sometimes described as running within a LibOS virtual machine), or in a software container, embodiments can be implemented fully with unikernels running directly on a hypervisor represented by virtualization layer 854, unikernels running within software containers represented by instances 862A-R, or as a combination of unikernels and the above-described techniques (e.g., unikernels and virtual machines both run directly on a hypervisor, unikernels and sets of applications that are run in different software containers).

The instantiation of the one or more sets of one or more applications 864A-R, as well as virtualization if implemented, are collectively referred to as software instance(s) 852. Each set of applications 864A-R, corresponding virtualization construct (e.g., instance 862A-R) if implemented, and that part of the hardware 840 that executes them (be it hardware dedicated to that execution and/or time slices of hardware temporally shared), forms a separate virtual network element(s) 860A-R.

The virtual network element(s) 860A-R perform similar functionality to the virtual network element(s) 830A-R-e.g., similar to the control communication and configuration module(s) 832A and forwarding table(s) 834A (this virtualization of the hardware 840 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 862A-R corresponding to one VNE 860A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 862A-R to VNEs also apply to embodiments where such a finer level of granularity and/or unikernels are used.

In certain embodiments, the virtualization layer 854 includes a virtual switch that provides similar forwarding services as a physical Ethernet switch. Specifically, this virtual switch forwards traffic between instances 862A-R and the physical NI(s) 846, as well as optionally between the instances 862A-R; in addition, this virtual switch may enforce network isolation between the VNEs 860A-R that by policy are not permitted to communicate with each other (e.g., by honoring virtual local area networks (VLANs)).

In one embodiment, software 850 includes code such as active node selection component 853, which when executed by processor(s) 842, causes the general purpose network device 804 to perform operations of one or more embodiments as part of software instances 862A-R (e.g., to support active node selection in a cluster, as described herein above).

The third exemplary ND implementation in FIG. 8A is a hybrid network device 806, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 802) could provide for para-virtualization to the networking hardware present in the hybrid network device 806.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 830A-R, VNEs 860A-R, and those in the hybrid network device 806) receives data on the physical NIs (e.g., 816, 846) and forwards that data out the appropriate ones of the physical NIs (e.g., 816, 846). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto. The specification and drawings are, accordingly, to be regarded in an illustrative sense rather than a restrictive sense.

1. A method by a node in a cluster of nodes to support active node selection in the cluster, wherein each node in the cluster is communicatively coupled to a notice board, the method comprising:
publishing, to the notice board, a record associated with the node that indicates a priority of the node and that indicates that the node is in a passive state;
changing a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster; and
modifying the record associated with the node on the notice board to indicate that the node is in the active state.

2. The method of claim 1, further comprising:
changing the state of the node from the active state to the passive state in response to a determination, based on a record on the notice board, that another node in the cluster is in the active state and has a higher priority than the node; and
modifying the record associated with the node on the notice board to indicate that the node is in the passive state.

3. The method of claim 1, further comprising:
generating the priority of the node using a random number generator.

4. The method of claim 1, further comprising:
storing the priority of the node in a non-volatile memory of the node; and
retrieving the priority of the node from the non-volatile memory of the node after a reboot of the node.

5. The method of claim 3, wherein the priority of the node also functions as an identifier of the node.

6. The method of claim 1, wherein the notice board is implemented using an eventually consistent data store.

7. The method of claim 6, further comprising:
subscribing to the notice board to receive notifications regarding appearances of new records on the notice board, modifications to existing records on the notice board, and disappearances of records from the notice board.

8. The method of claim 7, wherein the determination that there are no other available nodes in the cluster is based on not receiving any notifications from the notice board for a predetermined timeout length after subscribing to the notice board.

9. The method of claim 7, wherein the determination that all of the other available nodes in the cluster are in the passive state and the node has a higher priority than all of the other available nodes in the cluster is made based on receiving a notification from the notice board regarding records associated with all other nodes in the cluster without waiting for a predetermined timeout length.

10. The method of claim 7, wherein the determination that there are no other available nodes in the cluster is based on receiving notifications from the notice board indicating that records associated with all other nodes in the cluster have disappeared from the notice board.

11. The method of claim 1, further comprising:
determining, based on a record on the notice board while the node is in the passive state, that another node in the cluster is in the active state, wherein the another node has a lower priority than the node; and
remaining in the passive state despite the another node having a lower priority than the node.

12. The method of claim 1, further comprising:
receiving, from an operator, a request to change the state of the node from the active state to the passive state;
changing the state of the node from the active state to the passive state in response to receiving the request; and
modifying the record associated with the node on the notice board to indicate that the node is in the passive state, wherein the record associated with the node on the notice board being modified to indicate that the node in the passive state causes a state of another node in the cluster that has a higher priority than the node to change from the passive state to the active state.

13. The method of claim 1, further comprising:
changing the state of the node from the active state to the passive state in response to a determination, based on a record on the notice board, that another node in the cluster is in the passive state and has a higher priority than the node; and
modifying the record associated with the node on the notice board to indicate that the node is in the passive state, wherein the record associated with the node on the notice board being modified to indicate that the node in the passive state causes a state of the another node to change from the passive state to the active state.

14. The method of claim 13, wherein the priority of the node is assigned by an operator.

15. The method of claim 1, further comprising:
determining, based on a record on the notice board while the node is in the active state, that another node in the cluster is in the passive state, wherein the another node has a higher priority than the node; and
remaining in the active state despite the another node having a higher priority than the node.

16. The method of claim 15, wherein the priority of the node is generated randomly.

17. A non-transitory machine-readable storage medium that provides instructions that, if executed by one or more processors of a computing device implementing a node in a cluster of nodes, will cause said node to perform operations for supporting active node selection in the cluster, wherein each node in the cluster is communicatively coupled to a notice board, the operations comprising:
publishing, to the notice board, a record associated with the node that indicates a priority of the node and that indicates that the node is in a passive state;
changing a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster; and
modifying the record associated with the node on the notice board to indicate that the node is in the active state.

18. The non-transitory machine-readable storage medium of claim 17, wherein the operations further comprise:
changing the state of the node from the active state to the passive state in response to a determination, based on a record on the notice board, that another node in the cluster is in the active state and has a higher priority than the node; and
modifying the record associated with the node on the notice board to indicate that the node is in the passive state.

19. A computing device to implement a node in a cluster of nodes, wherein each node in the cluster is communicatively coupled to a notice board, the computing device comprising:
one or more processors; and
a non-transitory machine-readable medium having computer code stored therein, which when executed by the one or more processors, causes the node to:
publish, to the notice board, a record associated with the node that indicates a priority of the node and that indicates that the node is in a passive state,
change a state of the node from the passive state to an active state in response to a determination, based on one or more records on the notice board or a lack thereof, that there are no other available nodes in the cluster or that all of the other available nodes in the cluster are in the passive state and the node has a higher priority than all of the other available nodes in the cluster, and
modify the record associated with the node on the notice board to indicate that the node is in the active state.

20. The computing device of claim 19, wherein the computer code, when executed by the one or more processors, further causes the node to:
change the state of the node from the active state to the passive state in response to a determination, based on a record on the notice board, that another node in the cluster is in the active state and has a higher priority than the node and modify the record associated with the node on the notice board to indicate that the node is in the passive state.
